(19) United States
(12) Patent Application Publication
(10) Pub. No.: US 2016/0247200 A1
(43) Pub. Date: Aug. 25, 2016

(54) INFORMATION PRESENTATION APPARATUS

(71) Applicant: Panasonic Intellectual Property Management Co., Ltd., Osaka (JP)

(72) Inventor: Koichiro YAMAGUCHI, Osaka (JP)

(21) Appl. No.: 15/042,643

(22) Filed: Feb. 12, 2016

(30) Foreign Application Priority Data
Feb. 25, 2015 (JP) 2015-035045
Dec. 3, 2015 (JP) 2015-236228

(51) Int. Cl. G06Q 30/02

(52) U.S. Cl. CPC G06Q 30/0266

(57) ABSTRACT

An information presentation apparatus includes a transmitter and receiver that transmits and receives a plurality of pieces of advertisement information regarding respective places along a movement route of a movable body as the movable body moves, a memory that accumulates the plurality of pieces of advertisement information received by the transmitter and receiver, and a display that displays the plurality of pieces of advertisement information. The information presentation apparatus also includes a controller that controls preferential display of advertisement information on the display with predetermined timing, the advertisement information being among the plurality of pieces of advertisement information accumulated in the memory, and regarding each of the places at a short distance from the movable body that acquires the plurality of pieces of advertisement information along the movement route of the movable body, or regarding each of the places where time after acquisition is short.

### BACKGROUND

1. Technical Field

The present disclosure relates to an information presentation apparatus that presents information.

2. Description of the Related Art

Known techniques deliver various pieces of information to a driver who is driving a vehicle such as an automobile.

For example, the technique disclosed in Unexamined Japanese Patent Publication No. 2003-337905 (hereinafter referred to as “Patent Literature 1”) receives advertisement information and displays outline advertisement information included in the advertisement information on determination that a vehicle exists within a delivery area. Then, in a case where determination is made that the vehicle exists within a presentation area when the vehicle stops, detailed advertisement information will be displayed.

### SUMMARY

An information presentation apparatus of the present disclosure includes a transmitter and receiver that transmits and receives a plurality of advertisement information regarding respective places along a movement route of a movable body as the movable body moves, a memory that accumulates the plurality of pieces of advertisement information received by the transmitter and receiver, and a display that displays the plurality of pieces of advertisement information. The information presentation apparatus further includes a controller that controls preferential display of advertisement information on the display with predetermined timing, the advertisement information being among the plurality of pieces of advertisement information accumulated in the memory, and regarding each of the places at a short distance from the movable body that acquires the plurality of pieces of advertisement information along the movement route of the movable body, or regarding each of the places where time after acquisition is short.

### BRIEF DESCRIPTION OF DRAWINGS

FIG. 1 is a diagram illustrating an outline of an information presentation system according to the present exemplary embodiment;

FIG. 2 is a diagram illustrating a configuration of a recommendation apparatus according to the present exemplary embodiment;

FIG. 3 is a diagram illustrating a configuration of a cloud server according to the present exemplary embodiment;

FIG. 4 is a diagram illustrating a configuration of a store apparatus according to the present exemplary embodiment;

FIG. 5 is a flowchart illustrating a preparation operation of advertisement information according to the present exemplary embodiment;

FIG. 6 is a flowchart illustrating an accumulation operation of the advertisement information according to the present exemplary embodiment;

FIG. 7 is an image diagram illustrating the accumulation operation of the advertisement information according to the present exemplary embodiment;

FIG. 8 is an image diagram illustrating the accumulation operation of the advertisement information according to the present exemplary embodiment;

FIG. 9 is an image diagram illustrating the accumulation operation of the advertisement information according to the present exemplary embodiment;

FIG. 10 is an image diagram illustrating the accumulation operation of the advertisement information according to the present exemplary embodiment;

FIG. 11 is an image diagram illustrating the accumulation operation of the advertisement information according to the present exemplary embodiment;

FIG. 12 is an image diagram illustrating the accumulation operation of the advertisement information according to the present exemplary embodiment;

FIG. 13 is a flowchart illustrating a display determination operation of the advertisement information according to the present exemplary embodiment;

FIG. 14A is an image diagram illustrating an example of navigation information on a display form of the advertisement information according to the present exemplary embodiment;

FIG. 14B is an image diagram illustrating an example of outline information on the display form of the advertisement information according to the present exemplary embodiment;

FIG. 14C is an image diagram illustrating an example of detailed information on the display form of the advertisement information according to the present exemplary embodiment;

FIG. 15 is a flowchart illustrating the accumulation operation of memo information according to the present exemplary embodiment;

FIG. 16 is a flowchart illustrating a coupon issue operation according to the present exemplary embodiment; and

FIG. 17 is a flowchart illustrating the accumulation operation of the advertisement information that utilizes the memo information according to the present exemplary embodiment.

### DETAILED DESCRIPTION

### Exemplary Embodiment

### 1. Configuration

The following describes a configuration of an information presentation system according to the present exemplary embodiment.

### [1-1. Outline of the Information Presentation System]

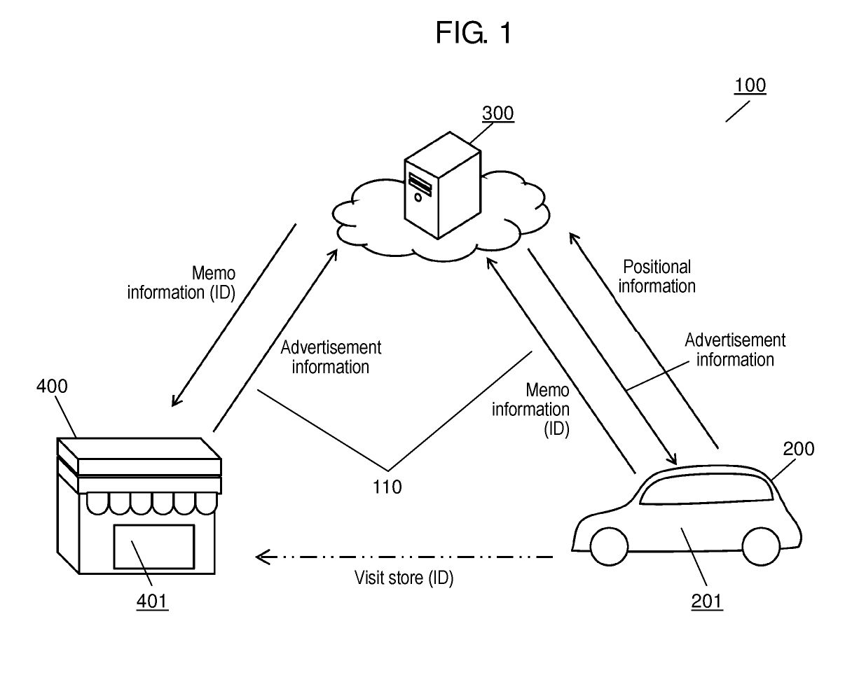

FIG. 1 is a diagram illustrating an outline of the information presentation system according to the present exemplary embodiment.

As illustrated in FIG. 1, information presentation system 100 includes recommendation apparatus 201 that constitutes an information presentation apparatus associated with a movable body, cloud server 300, and store apparatuses 401 installed in stores 400 corresponding to a plurality of places, respectively. When the movable body is automobile 200, recommendation apparatus 201 is installed within a vehicle of automobile 200. Each store apparatus 401 is installed within each store 400. The movable body is not limited to a vehicle such as automobile 200 described above. For example, the movable body may be an owner himself or herself who owns and moves associated recommendation apparatus 201. In this case, recommendation apparatus 201 corresponds to a portable information terminal, such as a tablet terminal, cellular phone, and smart phone, for example. Each place is not limited to store 400, but may be an information dissemination place that desires to inform advertisement information outside, such as a sightseeing area, event site, and amusement park, for example.

The following describes an information presentation method of the information presentation system with the aforementioned configuration.

The following specific description takes automobile 200 as an example of the movable body, and takes store 400 as an example of the place.

In information presentation system 100 according to the present exemplary embodiment, recommendation apparatus 201 and cloud server 300 are connected to each other via network 110, and cloud server 300 and store apparatus 401 are connected to each other via network 110, to communicate various pieces of information.

Specifically, first, store apparatus 401 transmits advertisement information regarding store 400 to cloud server 300. Cloud server 300 accumulates the advertisement information on store 400.

Recommendation apparatus 201 transmits positional information on automobile 200 (such as geographical position at which automobile 200 is currently running) to cloud server 300. In response to the positional information, cloud server 300 delivers the accumulated advertisement information on store 400 and the like to recommendation apparatus 201, based on a condition which will be described in detail later. This allows a user who is riding in automobile 200, such as a driver and a passenger, to read the advertisement information on store 400 and the like via recommendation apparatus 201. Furthermore, while reading the advertisement information, the user may make a memo of (stores) necessary advertisement information as memo information.

Then, recommendation apparatus 201 transmits the memo information related to the memo together with user ID information to cloud server 300. Cloud server 300 transmits the memo information together with the user ID information to store apparatus 401. This allows store 400 to provide various services, such as issuing coupons, efficiently to the user who comes to the store by automobile 200 and the like.

As described above, information presentation system 100 according to the present exemplary embodiment executes presentation of information on store 400 and the like to the user, such as a driver, via the information presentation apparatus such as recommendation apparatus 201.

Next, the following describes configurations of recommendation apparatus 201, cloud server 300, and store apparatus 401 sequentially.

### [1-2. Configuration of the Recommendation Apparatus]

Recommendation apparatus 201 is installed in a place the user such as a driver may easily identify visually, for example, in an instrument panel within automobile 200.

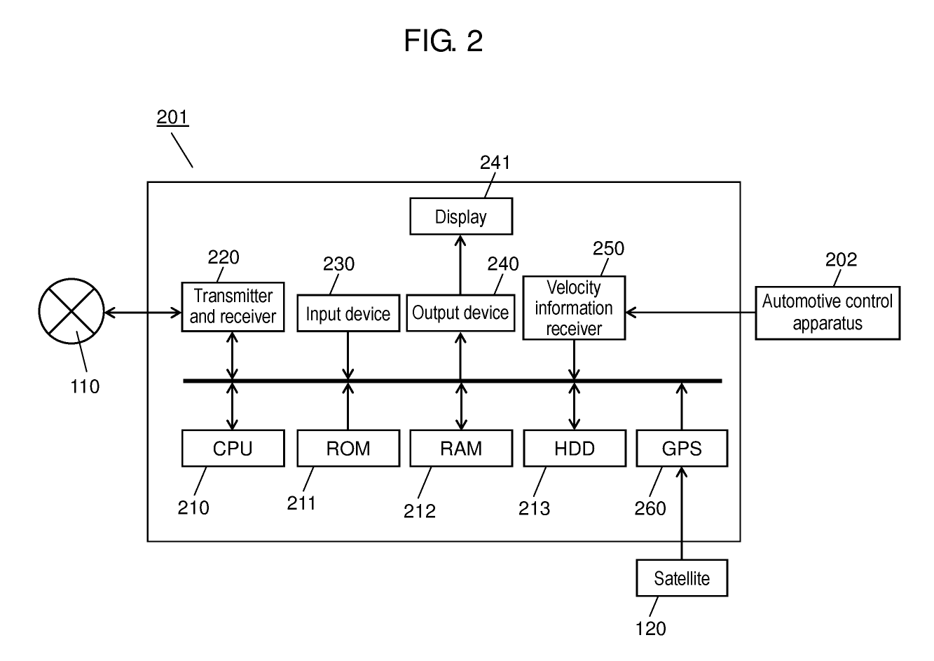

FIG. 2 is a diagram illustrating a configuration of the recommendation apparatus according to the present exemplary embodiment.

As illustrated in FIG. 2, recommendation apparatus 201 that constitutes the information presentation apparatus includes CPU 210, ROM 211, RAM 212, HDD 213, transmitter and receiver 220, input device 230, output device 240, display 241, velocity information receiver 250, and GPS 260. Here, CPU is an abbreviation of Central Processing Unit, ROM is an abbreviation of Read Only Memory, RAM is an abbreviation of Random Access Memory, HDD is an abbreviation of Hard Disk Drive, and GPS is an abbreviation of Global Positioning System.

CPU 210 constitutes a controller, and controls each unit that constitutes recommendation apparatus 201. CPU 210 accesses ROM 211, RAM 212, and HDD 213 to execute necessary control. ROM 211 stores a program for controlling each unit that constitutes recommendation apparatus 201, etc. RAM 212 and HDD 213 constitute a memory and store the advertisement information, etc. to be described in detail later.

CPU 210 uses transmitter and receiver 220 as an interface to communicate various pieces of information with cloud server 300 via network 110. Transmitter and receiver 220 may adopt arbitrary telecommunications standards, such as 4G (4th Generation) and Wi-Fi (Wireless Fidelity), for example.

Furthermore, CPU 210 uses input device 230 as an interface to accept input from the user. CPU 210 controls each unit according to input information. Input device 230 may adopt a hard key, touch panel, etc., for example.

CPU 210 displays information, such as video, on display 241 via output device 240. Here, display 241 may adopt an arbitrary display system, such as a liquid crystal system and organic EL (Electro Luminescence) system, for example.

Furthermore, CPU 210 uses velocity information receiver 250 as an interface to acquire information regarding current running velocity of automobile 200 from automotive control apparatus 202. Here, automotive control apparatus 202 constitutes an apparatus that controls running of automobile 200.

CPU 210 also acquires the positional information on automobile 200 (geographical information, etc. on the position at which automobile 200 is currently running) from satellite 120 via GPS 260.

Recommendation apparatus 201 of information presentation system 100 is configured as described above.

### [1-3. Configuration of the Cloud Server]

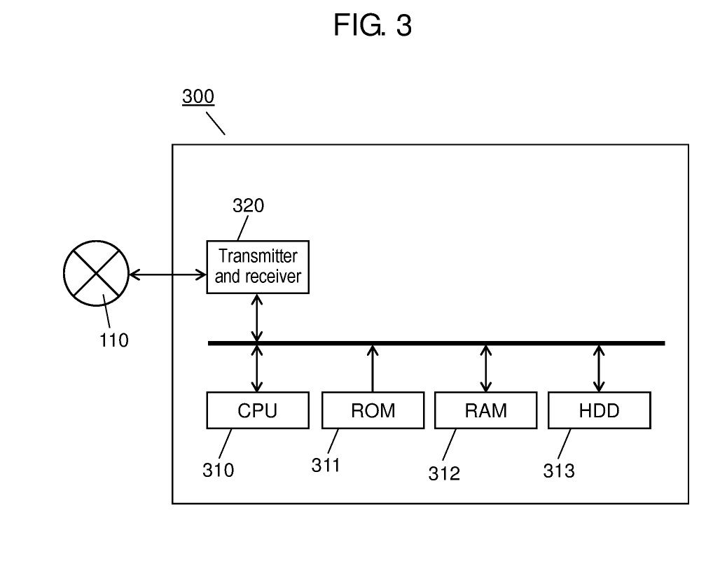

FIG. 3 is a diagram illustrating the configuration of the cloud server according to the present exemplary embodiment.

As illustrated in FIG. 3, cloud server 300 includes CPU 310, ROM 311, RAM 312, HDD 313, and transmitter and receiver 320.

CPU 310 constitutes a controller, and controls each unit that constitutes cloud server 300. CPU 310 accesses ROM 311, RAM 312, and HDD 313 to execute necessary control. ROM 311 stores a program for controlling each unit that constitutes cloud server 300, etc. RAM 312 is used as a working memory for CPU 310. HDD 313 stores the advertisement information and memo information to be described in detail later. Furthermore, HDD 313 records map information and the like including road information that indicates at least existence of roads.

CPU 310 uses transmitter and receiver 320 as an interface to communicate various pieces of information with recommendation apparatus 201 and store apparatus 401 via network 110. Transmitter and receiver 320 may adopt arbitrary telecommunications standards, such as 4G and Wi-Fi, for example, which allow communication with recommendation apparatus 201 and store apparatus 401.

Cloud server 300 of information presentation system 100 is configured as described above.

### [1-4. Configuration of the Store Apparatus]

Store apparatus 401 is installed in an arbitrary place, such as beside a checkout counter and in a staff room within store 400.

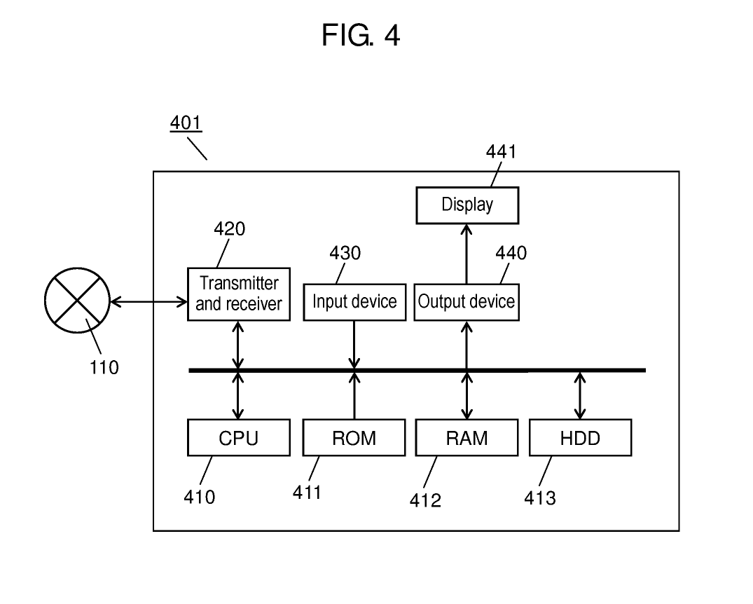

FIG. 4 is a diagram illustrating the configuration of the store apparatus according to the present exemplary embodiment.

As illustrated in FIG. 4, store apparatus 401 includes CPU 410, ROM 411, RAM 412, HDD 413, transmitter and receiver 420, input device 430, output device 440, and display 441.

CPU 410 constitutes a controller, and controls each unit that constitutes store apparatus 401. CPU 410 accesses ROM 411, RAM 412, and HDD 413 to execute necessary control. ROM 411 stores a program for controlling each unit that constitutes store apparatus 401, etc. RAM 412 is used as a working memory for CPU 410. HDD 413 stores memo information, etc. to be described in detail later.

CPU 410 uses transmitter and receiver 420 as an interface to communicate various pieces of information with cloud server 300 via network 110. Transmitter and receiver 420 may adopt arbitrary telecommunications standards, such as 4G and Wi-Fi, for example, which allow communication with cloud server 300.

Furthermore, CPU 410 uses input device 430 as an interface to accept input from a salesclerk of store 400, etc. CPU 410 controls each unit according to input information. Input device 430 may adopt a hard key, touch panel, etc., for example.

CPU 410 displays information, such as video, on display 441 via output device 440. Here, display 441 may adopt arbitrary display systems, such as a liquid crystal system and organic EL (Electro Luminescence) system, for example.

Store apparatus 401 of information presentation system 100 is configured as described above.

### [2. Operation]

Next, the following describes operations of recommendation apparatus 201, cloud server 300, and store apparatus 401, which constitute information presentation system 100 according to the present exemplary embodiment.

### [2-1. Outline of the Operation of the Information Presentation System]

First, an outline of the operation of information presentation system 100 will be described.

Information presentation system 100 provides a solution for presenting information which is overlooked or unnoticed until now, and for preferably making a memo easily, to the user who is riding in automobile 200, such as a driver and passenger.

Specifically, recommendation apparatus 201 first receives a plurality piece of advertisement information regarding, for example, each of stores 400 respectively corresponding to the plurality of places along a movement route such as a running route of automobile 200, in the order in which automobile 200 runs. The plurality pieces of received advertisement information are sequentially accumulated in the memory including RAM 212, HDD 213, and the like. At this time, information such as time when the advertisement information is acquired and an update history is also simultaneously accumulated in the memory.

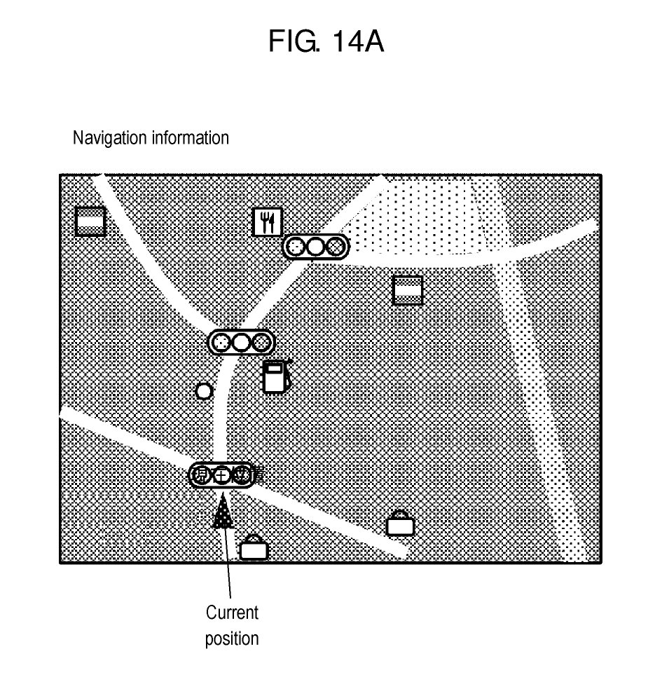

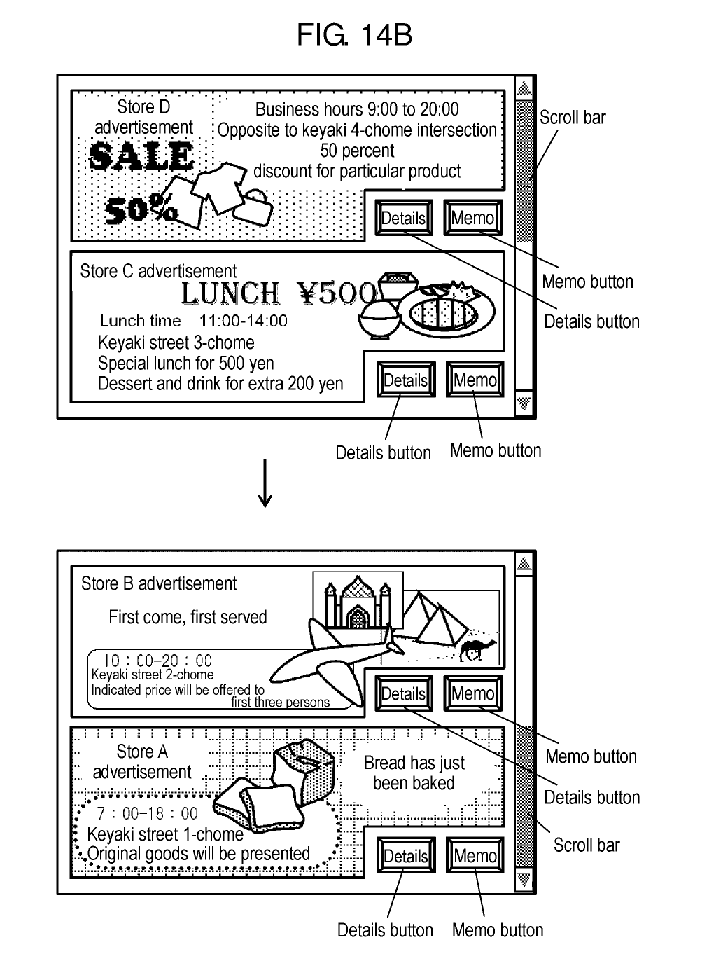

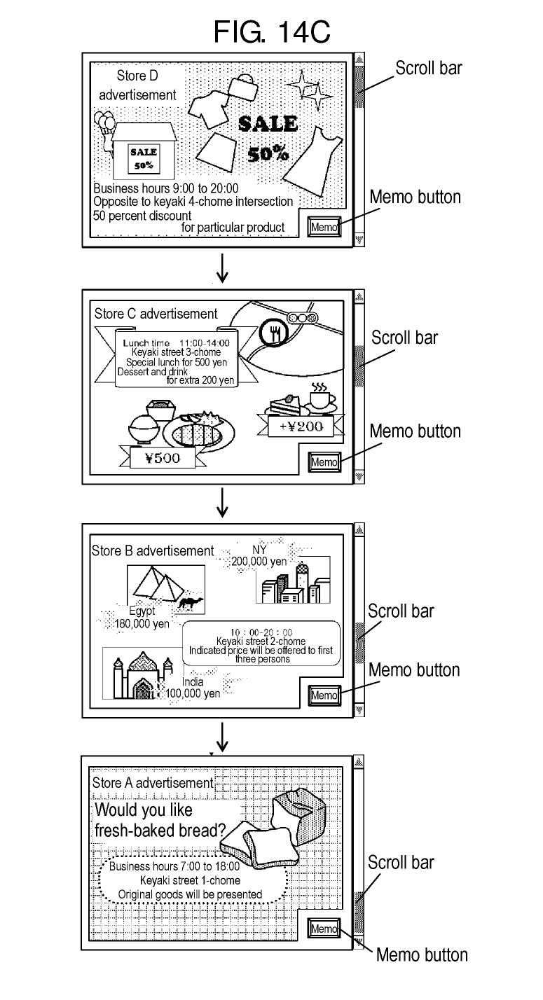

Then, with predetermined timing, for example, when it is determined that automobile 200 has stopped, CPU 210 that constitutes the controller of recommendation apparatus 201 displays, on display 241, the advertisement information from among the accumulated plurality of pieces of advertisement information, for example, in accordance with priority. Specifically, along the running route of automobile 200, CPU 210 displays, on display 241 with priority, the advertisement information regarding store 400 at a short distance from automobile 200 or regarding store 400 with short time after acquisition of the advertisement information. In this case, it is not necessarily required to display the advertisement information in increasing order of distance to store 400 or increasing order of time after acquisition of the advertisement information on store 400. For example, within a predetermined area, the advertisement information on store 400 at a short distance or on store 400 with short time after acquisition may be displayed in decreasing order of distance or in random order. The advertisement information may be displayed simultaneously with manipulation of a memo button for prompting memo (refer to FIG. 14B and FIG. 14C). This allows the user such as a driver to obtain useful information more efficiently for utilization.

The following describes details of the operation of information presentation system 100.

### [2-2. Preparation Operation of the Advertisement Information]

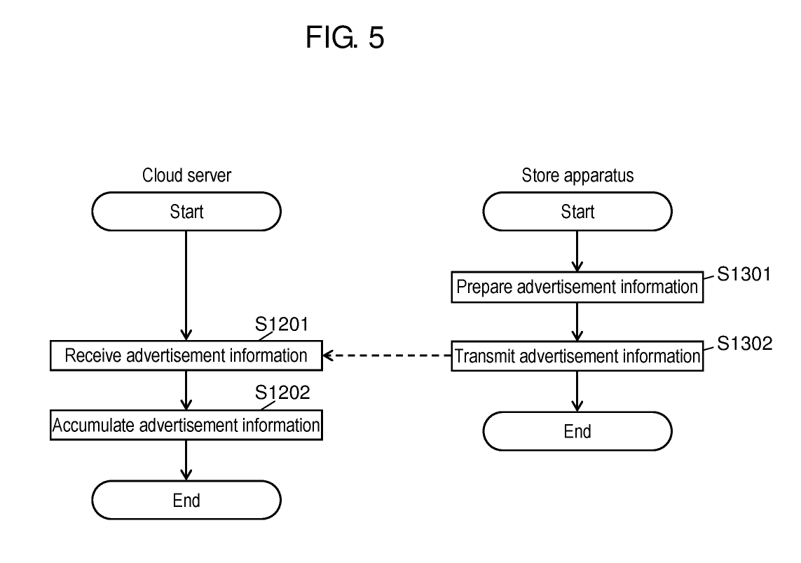

First, a preparation operation of the advertisement information in information presentation system 100 will be described with reference to FIG. 5.

FIG. 5 is a flowchart illustrating the preparation operation of the advertisement information according to the present exemplary embodiment. FIG. 5 illustrates operation flows of cloud server 300 and store apparatus 401.

As illustrated in FIG. 5, first, CPU 410 of store apparatus 401 accepts input manipulation performed by the salesclerk of store 400 via input device 430. This leads to preparation of the advertisement information regarding store 400 (step S1301). Specifically, the salesclerk performs input manipulation, for example, so as to fill in a predetermined format to prepare the advertisement information regarding store 400. The predetermined format is configured to allow entry of information such as a store name, attribute (industry attribute, such as restaurant, general store, and travel agency), descriptive text about the store, positional information (address of the store), menu, price, business hours, images of merchandise and external appearance and interior of the store. In this case, in particular, the store name, descriptive text about the store, and positional information (address of the store) are essential information.

Furthermore, the predetermined format is configured to allow entry of outline information and detailed information illustrated in FIG. 14B and FIG. 14C to be described later. The outline information receives entry of the advertisement information such as an image of a relatively small size. On the other hand, the detailed information receives entry of the advertisement information such as an image of a relatively large size.

FIG. 14B is an image diagram illustrating the outline information on a display form of the advertisement information according to the present exemplary embodiment. FIG. 14C is an image diagram illustrating the detailed information on the display form of the advertisement information according to the present exemplary embodiment. Here, FIG. 14B illustrates the outline information on a store A to store D as an example. FIG. 14C illustrates the detailed information on the store A to store D as an example. At this time, display of the outline information illustrated in FIG. 14B and display of the detailed information illustrated in FIG. 14C may be switched by manipulation of, for example, a detailed button, etc. displayed on display 241. Furthermore, as will be described later, the outline information and the detailed information are switched automatically and displayed according to displayable prediction time. This allows the user to select displayed appropriate image information to utilize the obtained information.

Next, CPU 410 of store apparatus 401 transmits the advertisement information completely prepared by salesclerk's entry, from transmitter and receiver 420 to cloud server 300 via network 110 (step S1302). The transmission to cloud server 300 may be performed at predetermined intervals, and may be performed when the prepared advertisement information is updated.

Transmitter and receiver 320 of cloud server 300 receives the advertisement information transmitted from store apparatus 401 (step S1201). CPU 310 of cloud server 300 then accumulates the received advertisement information, for example, in a storage medium such as HDD 313 by overwriting existing information (step S1202).

As described above, the advertisement information regarding store 400 is prepared and stored in cloud server 300.

### [2-3. Accumulation Operation of the Advertisement Information]

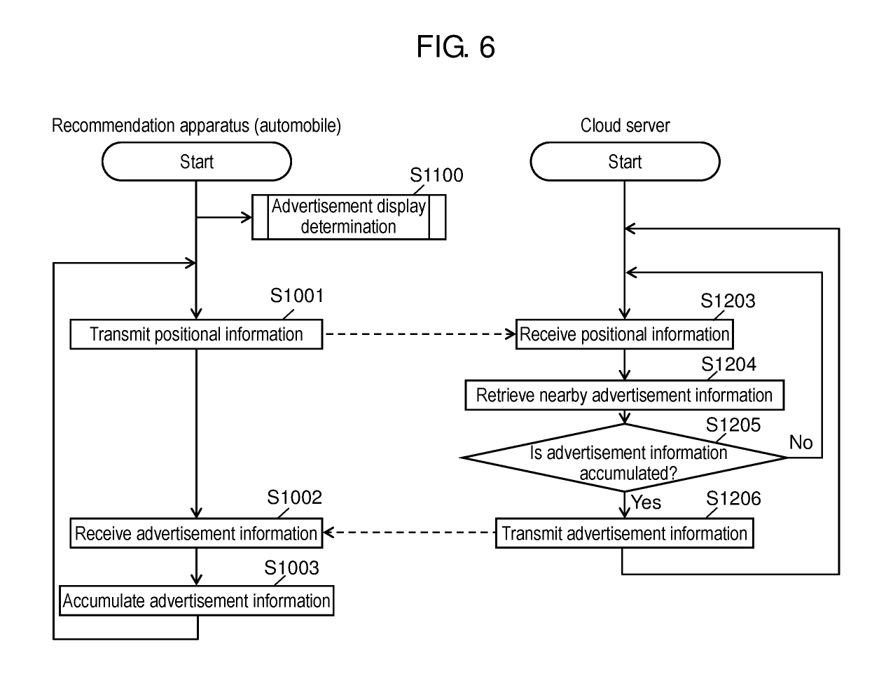

Next, an accumulation operation of the advertisement information into recommendation apparatus 201 in information presentation system 100 will be described with reference to FIG. 6.

FIG. 6 is a flowchart illustrating the accumulation operation of the advertisement information according to the present exemplary embodiment. FIG. 6 illustrates operation flows of recommendation apparatus 201 and cloud server 300.

First, recommendation apparatus 201 starts the operation by using, for example, startup of an engine of automobile 200 as a trigger.

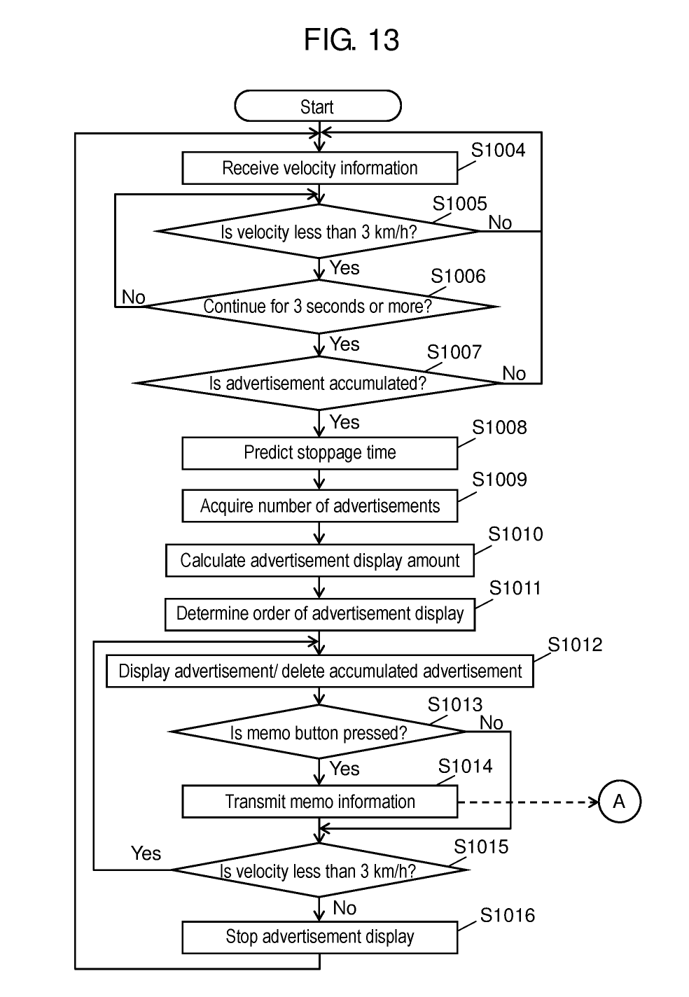

Specifically, as illustrated in FIG. 6, recommendation apparatus 201 executes a transmission operation of the positional information (step S1001) and an advertisement display determination operation (step S1100) simultaneously. Details of the advertisement display determination operation will be described later with reference to FIG. 13.

Next, when the transmission operation starts, transmitter and receiver 220 of recommendation apparatus 201 transmits the positional information on automobile 200 acquired from GPS 260 (such as the current geographical position) to cloud server 300 (step S1001).

Cloud server 300 receives the positional information on automobile 200 transmitted from recommendation apparatus 201 (step S1203).

Based on the received positional information on automobile 200, cloud server 300 retrieves the advertisement information on store 400 that has positional information near running automobile 200 along the movement route such as the running route of automobile 200 (step S1204). Here, the positional information near automobile 200 refers to, for example, when a threshold of distance between automobile 200 and store 400 is previously defined, positional information on store 400 that exists within a range equal to or less than the threshold.

Next, based on the positional information (such as the address of the store) included in the advertisement information on each store 400, cloud server 300 finds out whether the advertisement information is accumulated in the memory such as RAM 312 and HDD 313 (step S1205). At this time, cloud server 300 does not include store 400 near automobile 200 in search results, if store 400 does not exist along the running route of automobile 200. This allows cloud server 300 to extract only advertisement information on store 400 that exists along the running route of automobile 200.

When the advertisement information is not accumulated in HDD 313 (No in step S1205), cloud server 300 returns to a standby state of receiving the positional information in step S1203.

On the other hand, when the advertisement information is accumulated in HDD 313 (Yes in step S1205), cloud server 300 transmits the retrieved advertisement information to recommendation apparatus 201 (step S1206). Then, after transmitting the advertisement information to recommendation apparatus 201, cloud server 300 returns to the standby state of receiving the positional information in step S1203.

Next, recommendation apparatus 201 receives the advertisement information transmitted from cloud server 300 via transmitter and receiver 220 (step S1002). Recommendation apparatus 201 then accumulates the received advertisement information in the storage medium that constitutes the memory, such as RAM 212 and HDD 213 (step S1003).

That is, recommendation apparatus 201 transmits the positional information on automobile 200 to cloud server 300 regularly (for example, at intervals of 1 second) in step S1001. Then, when corresponding advertisement information on store 400 is accumulated in the memory of cloud server 300, recommendation apparatus 201 receives the advertisement information one by one from cloud server 300, and accumulates the advertisement information in the memory. This allows recommendation apparatus 201 to accumulate the advertisement information on store 400 in the memory sequentially along the running route of automobile 200. At this time, when receiving the advertisement information on the plurality of stores 400 at a time, recommendation apparatus 201 accumulates the advertisement information in order from store 400 far from the current positional information on automobile 200 along the running route of automobile 200.

Note that, when automobile 200 moves along the identical movement route again, even if cloud server 300 retrieves and transmits the advertisement information which is displayed on display 241 before and is then deleted from the memory of recommendation apparatus 201, recommendation apparatus 201 does not accumulate the advertisement information in the memory until a predetermined period (for example, one week) elapses. However, even within the predetermined period, when the advertisement information is updated, recommendation apparatus 201 may store the updated advertisement information in the memory, and may display the advertisement information again when retrieved. This may prevent overlapped storage.

As described above, the accumulation operation of the advertisement information into recommendation apparatus 201 in information presentation system 100 is executed.

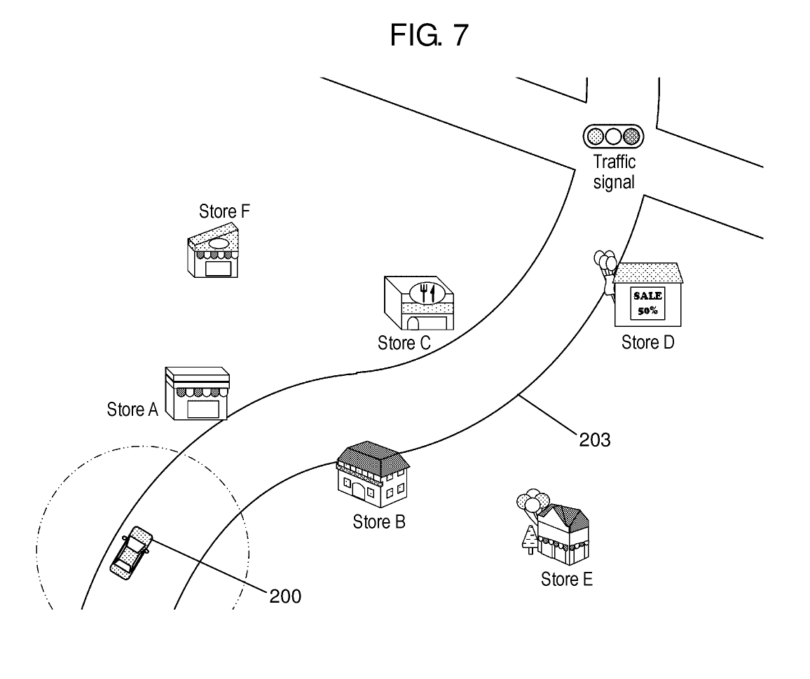

The following describes the accumulation operation of the advertisement information into recommendation apparatus 201 in information presentation system 100 based on specific positional relationship between automobile 200 and store 400 with reference to FIG. 7 to FIG. 12.

FIG. 7 to FIG. 12 are image diagrams illustrating the accumulation operation of the advertisement information according to the present exemplary embodiment. FIG. 7 to FIG. 12 illustrate a case where automobile 200 runs along a certain running route 203 (road) for the first time. Furthermore, FIG. 7 to FIG. 12 each illustrate a case where several stores 400 are located at positions relatively near automobile 200 as an example, stores 400 having advertisement information already accumulated in cloud server 300. As stores 400, for example, the store A, store B, store C, store D, store E, and store F are illustrated.

FIG. 7 to FIG. 12 are illustrated on a time-series basis in the order in which automobile 200 runs along running route 203. A circle drawn in a two-dot chain line about a position of automobile 200 in FIG. 7 to FIG. 12 represents the aforementioned threshold that is a range used for determining that the distance from automobile 200 is short.

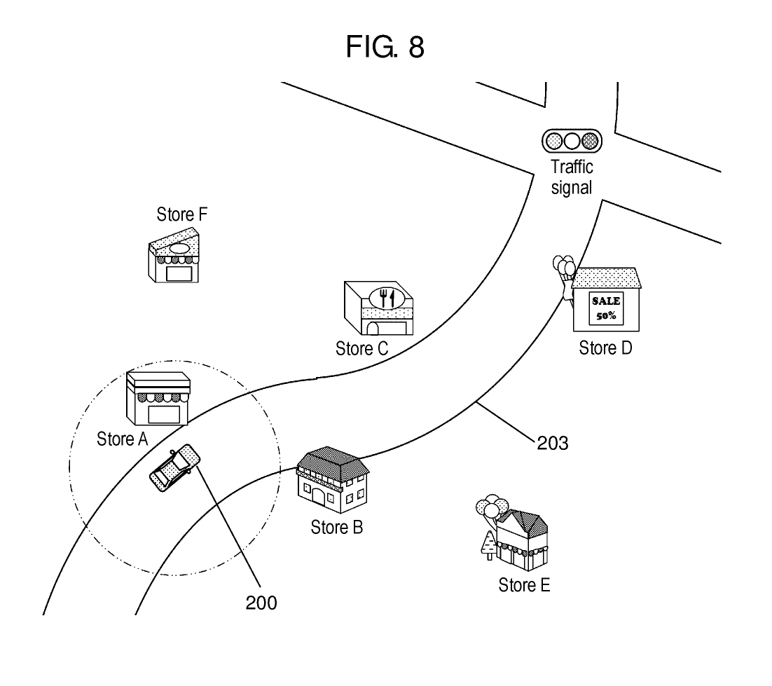

Specifically, FIG. 7 illustrates timing when automobile 200 is running along running route 203 and no store exists within the range of short distance (equal to or less than the threshold). FIG. 8 illustrates timing when automobile 200 further runs from timing illustrated in FIG. 7 and the store A enters the range of short distance (threshold) from automobile 200. At this time, recommendation apparatus 201 receives the advertisement information on the store A from cloud server 300 via transmitter and receiver 220. Recommendation apparatus 201 then accumulates the advertisement information on the store A in the memory such as HDD 213.

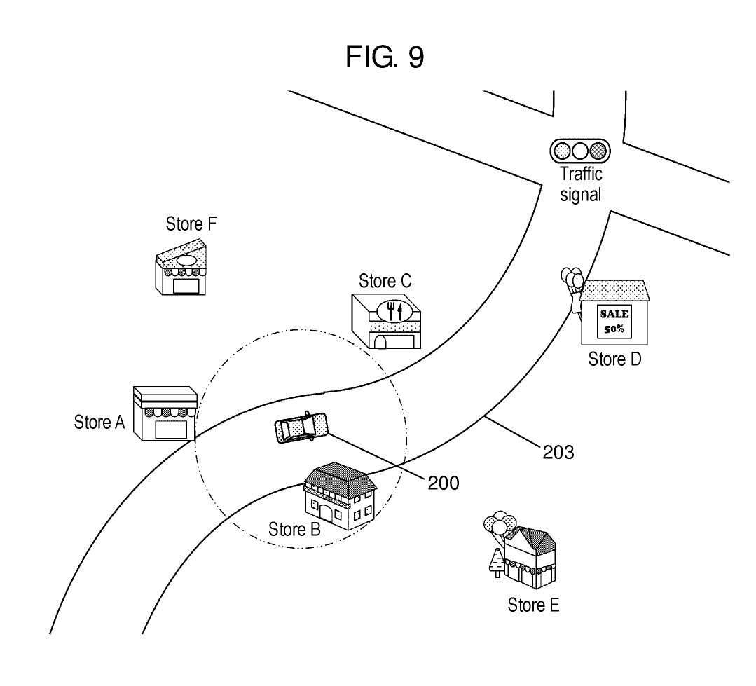

Also, FIG. 9 illustrates timing when automobile 200 further runs from timing illustrated in FIG. 8 and the store B enters the range of short distance (threshold) from automobile 200. At this time, recommendation apparatus 201 receives the advertisement information on the store B from cloud server 300 via transmitter and receiver 220. Recommendation apparatus 201 then accumulates the advertisement information on the store B in the memory such as HDD 213.

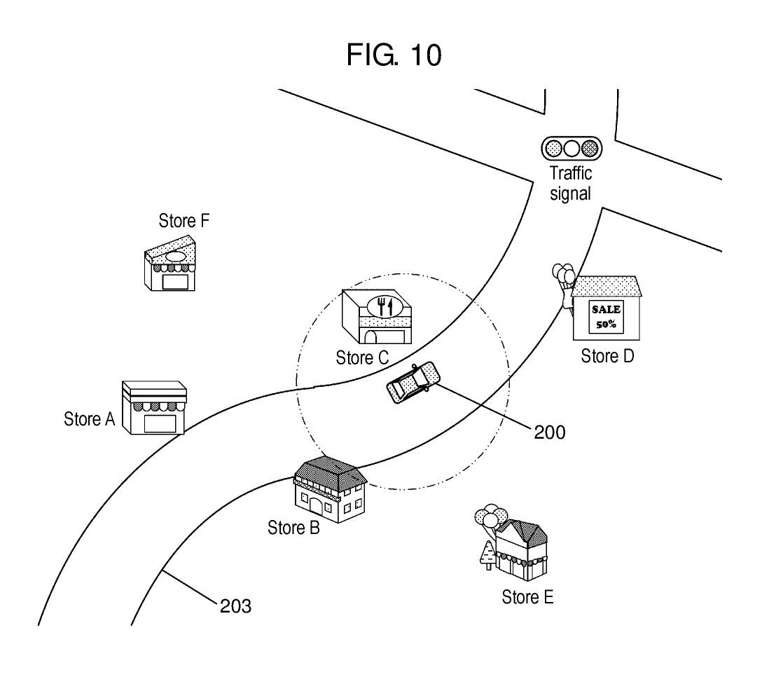

Furthermore, FIG. 10 illustrates timing when automobile 200 runs from timing illustrated in FIG. 9 and the store C enters the range of short distance (threshold) from automobile 200. At this time, recommendation apparatus 201 receives the advertisement information on the store C from cloud server 300 via transmitter and receiver 220. Recommendation apparatus 201 then accumulates the advertisement information on the store C in the memory such as HDD 213.

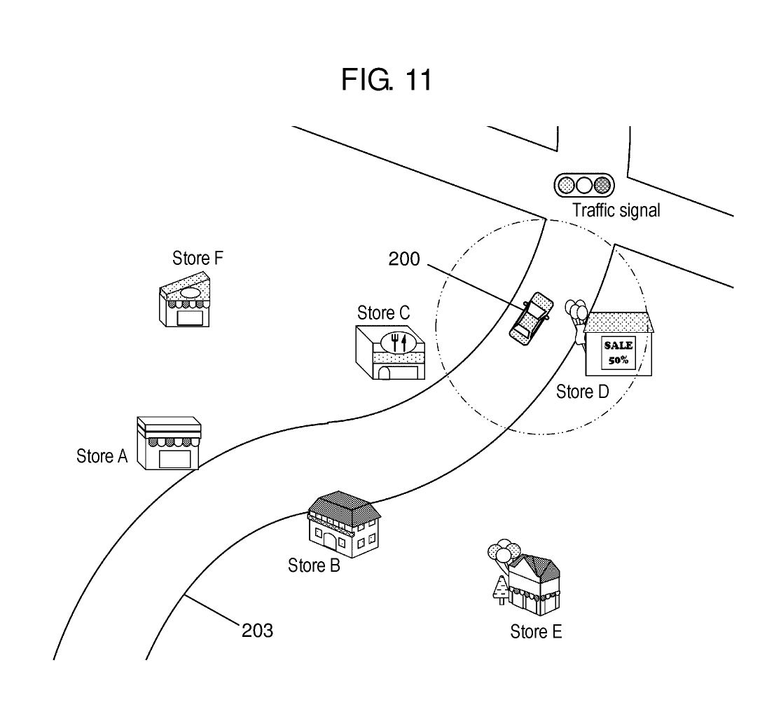

Also, FIG. 11 illustrates timing when automobile 200 further runs from timing illustrated in FIG. 10 and the store D enters the range of short distance (threshold) from automobile 200. At this time, recommendation apparatus 201 receives the advertisement information on the store D from cloud server 300 via transmitter and receiver 220. Recommendation apparatus 201 then accumulates the advertisement information on the store D in the memory such as HDD 213.

At this time, recommendation apparatus 201 accumulates acquisition time of the advertisement information on the store A to the store D to be accumulated in the memory together.

As described above, as automobile 200 runs along running route 203, in the order of the store A, store B, store C, and store D, recommendation apparatus 201 accumulates the advertisement information on each store together with the acquisition time of the advertisement information in the memory.

At this time, the store E and store F illustrated in FIG. 7 to FIG. 12 also exist at relatively near positions from automobile 200. However, since the distance of the store E or store F exceeds the range of distance (threshold) along running route 203 along which automobile 200 runs, recommendation apparatus 201 may not determine that the store E or store F is near. Accordingly, based on the positional information on automobile 200, cloud server 300 does not include the advertisement information on the store E or store F in search results. Therefore, recommendation apparatus 201 does not accumulate the advertisement information on the store E or store F in the memory.

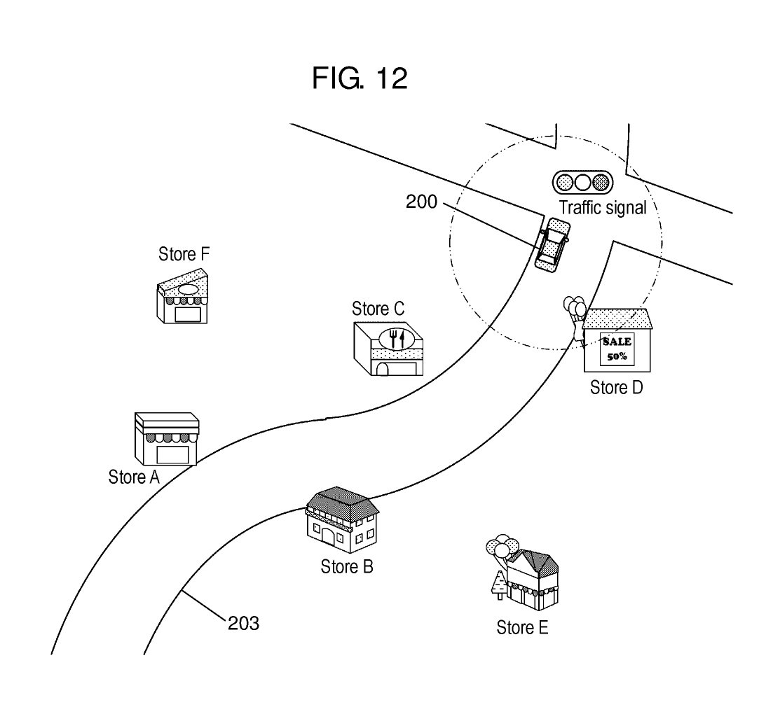

In addition, FIG. 12 illustrates timing when automobile 200 stops before a traffic signal, after automobile 200 runs as illustrated in FIG. 7 to FIG. 11 and recommendation apparatus 201 accumulates the advertisement information in the order of the store A, store B, store C, and store D. At this time, recommendation apparatus 201 displays the advertisement information and the like on display 241 in an appropriate number and display amount, based on predicted stoppage time to be described later.

Even in a case where the advertisement information on the store is transmitted from cloud server 300 while automobile 200 runs along running route 203 described above again, for example, within a predetermined period, such as one week, if the advertisement information is not updated, recommendation apparatus 201 does not accumulate the advertisement information in the memory.

In addition, when automobile 200 enters the middle of running route 203 along which automobile 200 has run before from an unillustrated running route, for example, when automobile 200 enters running route 203 along which the store C and store D exist from a running route along which the store E exists within the threshold, the advertisement information on each store is accumulated as follows. Then, recommendation apparatus 201 displays the advertisement information on display 241 with predetermined timing (for example, with timing when automobile 200 stops at the traffic signal).

First, cloud server 300 retrieves the advertisement information on the store E that exists along the route along which automobile 200 newly runs. The retrieved advertisement information is transmitted to recommendation apparatus 201, and is accumulated in the memory.

Next, after the advertisement information on the store E is obtained, when automobile 200 runs along running route 203 again within a predetermined period, the advertisement information on the store C and store D is retrieved by cloud server 300 and is transmitted. However, since the aforementioned advertisement information on the store C and store D is accumulated previously, or is displayed and deleted within the predetermined period, the advertisement information is not again accumulated in the memory of recommendation apparatus 201. In a case of exceeding the predetermined period or a case where the advertisement information is updated, however, the advertisement information is accumulated.

Next, as illustrated in FIG. 12, when automobile 200 stops before the traffic signal, the accumulated advertisement information on the stores will be displayed. At this time, the advertisement information on the store C and store D remains in the memory. When display is performed in increasing order of distance from automobile 200, the advertisement information is displayed in the order of the store D, store C, and store E. On the other hand, when display is performed in increasing order of time after acquisition of the advertisement information, the advertisement information is displayed in the order of the store E, store D, and store C. This corresponds to a case of strong impression at the store E which is a place where automobile 200 runs during a short period of time until stopping, and of displaying the advertisement information in consideration of user's high attention.

As described above, the accumulation operation of the advertisement information on stores 400 into recommendation apparatus 201 is executed in information presentation system 100.

### [2-4. Display Operation of the Advertisement Information]

Next, the display determination operation of the advertisement information in recommendation apparatus 201 of information presentation system 100 will be described with reference to FIG. 13.

FIG. 13 is a flowchart illustrating the display determination operation of the advertisement information according to the present exemplary embodiment. Here, the display determination operation corresponds to the advertisement display determination operation of step S1100 illustrated in FIG. 6, and is an operation flow of controlling display of the accumulated advertisement information.

As illustrated in FIG. 13, recommendation apparatus 201 receives velocity information transmitted from automotive control apparatus 202 via velocity information receiver 250 (step S1004). At this time, automotive control apparatus 202 transmits the velocity information, for example, at intervals of 1 second. Recommendation apparatus 201 receives the transmitted velocity information by velocity information receiver 250.

Next, CPU 210 that constitutes the controller of recommendation apparatus 201 determines whether the received velocity information is less than 3 km/h (step S1005). Here, 3 km/h, which is a criterion, is an example of velocity for determining whether automobile 200 has stopped, and is not particularly restrictive.

At this time, when CPU 210 determines that the velocity information is 3 km/h or more (No in step S1005), recommendation apparatus 201 returns to step S1004 again, and receives the velocity information.

On the other hand, when CPU 210 determines that the velocity information is less than 3 km/h (Yes in step S1005), recommendation apparatus 201 determines whether a state in which the velocity is below 3 km/h continues for 3 seconds or more (step S1006). Here, 3 seconds or more, which is a criterion, is an example of time for determining whether automobile 200 has stopped, and is not particularly restrictive.

At this time, when recommendation apparatus 201 determines that the state in which the velocity is below 3 km/h continues for less than 3 seconds (No in step S1006), recommendation apparatus 201 returns to step S1005. Then, until the state in which the velocity is less than 3 km/h continues for 3 seconds or more, recommendation apparatus 201 repeats the determination operation of step S1005 and step S1006.

On the other hand, when the velocity becomes 3 km/h or more (No in step S1005) before the state in which the velocity is less than 3 km/h (Yes in step S1005) continues for 3 seconds or more (No in step S1006), recommendation apparatus 201 returns to step S1004 again, and receives the velocity information.

Then, when recommendation apparatus 201 determines that the state in which the velocity is less than 3 km/h (Yes in step S1005) continues for 3 seconds or more (Yes in step S1006), recommendation apparatus 201 determines whether the advertisement information regarding store 400 is accumulated in RAM 212 or HDD 213 that constitutes the memory (step S1007). At this time, when recommendation apparatus 201 determines that the advertisement information is not accumulated (No in step S1007), recommendation apparatus 201 returns to step S1004 again, and receives the velocity information.

On the other hand, when the advertisement information is accumulated (Yes in step S1007), recommendation apparatus 201 predicts stoppage time of automobile 200 (step S1008). Here, the stoppage time is predicted based on information such as information from a car navigation system installed in automobile 200 and traffic information acquired via communications. Specifically, the stoppage time is predicted based on whether automobile 200 stops at a traffic signal or stops due to traffic congestion, that is, information such as waiting time at the traffic signal and prediction time of traffic congestion, which is obtained from the aforementioned information. This makes it possible to control display so as to display appropriate advertisement information within a range of predicted stoppage time.

Next, recommendation apparatus 201 acquires a number of advertisements accumulated in RAM 212 or HDD 213 (step S1009). Here, the number of advertisements to acquire may not be the number of all accumulated advertisements. For example, the number of advertisements to acquire may be the number of only advertisements on positional information on stores near the current position of automobile 200 (within the range of distance defined by the predetermined threshold).

Next, based on the predicted stoppage time, CPU 210 of recommendation apparatus 201 calculates the number of advertisements to display and a display amount of one advertisement to display (step S1010). Here, the number and display amount of the advertisement to display increase as the predicted stopping time is longer. At this time, when the number of advertisements to display is small, display time of one advertisement may be extended.

That is, CPU 210 calculates time to display one advertisement, for example, by dividing the predicted stopping time by the number of advertisements. In this case, when minimum display time (for example, 5 seconds) may not be secured, the number of acquired advertisements is further narrowed down in increasing order of distance for display, and other advertisements are not displayed. Then, based on time allocation obtained by calculation, recommendation apparatus 201 switches screen display on display 241 automatically to display the advertisements. At this time, outline information on the advertisement information is usually displayed with priority. This allows the user to be provided with more pieces of advertisement information.

In addition to the aforementioned display method, for example, when division of the predicted stopping time by the number of advertisements results in display time equal to or longer than a predetermined threshold, detailed information on the advertisement information may be displayed on display 241 from the beginning. On the other hand, when the aforementioned division results in display time shorter than the predetermined threshold, detailed information may not be displayed on display 241, but only outline information may be displayed. In this case, recommendation apparatus 201 may be configured to display the advertisement, only when the driver performs manipulation of detailed display. Furthermore, when the aforementioned division results in display time shorter than the predetermined threshold, calculation may be performed with the number of advertisements narrowed down, and minimum display time may be secured and displayed. This provides the user with advertisement display with appropriate display amount and appropriate time. As a result, the advertisement information may be securely presented to the user.

Next, CPU 210 of recommendation apparatus 201 determines the order of advertisement to display from the advertisement information accumulated in the memory (step S1011). Specifically, from the positional information on stopped automobile 200, recommendation apparatus 201 determines the display order in the order from the advertisement of the store near the stop position of automobile 200 along running route 203, or in the order from the advertisement of the store with short time after acquisition. That is, in the examples described from FIG. 7 to FIG. 12, recommendation apparatus 201 determines the order of the store D, store C, store B, and store A, which are near the position at which automobile 200 illustrated in FIG. 12 stops at the traffic signal, as the display order. Here, the display order may be decreasing order of distance (store A, store B, store C, store D), and may be displayed in random order, as long as the number of advertisements may be displayed within the stoppage time.

Next, recommendation apparatus 201 sequentially displays the advertisement information on the store D to store A on display 241 in accordance with the display order determined in step S1011. Then, recommendation apparatus 201 deletes the advertisement information displayed on display 241 from the memory such as RAM 212 and HDD 213 (step S1012). This causes the advertisement information accumulated before the deleted advertisement information to be sequentially advanced in order and accumulated. At this time, when automobile 200 departs before the predicted stoppage time elapses, the advertisement information that is being displayed is not deleted, but is accumulated in the memory. Here, the advertisement may be deleted immediately after the advertisement information is displayed, and may be deleted after a predetermined interval. For example, the advertisement information may be deleted after automobile 200 departs again.

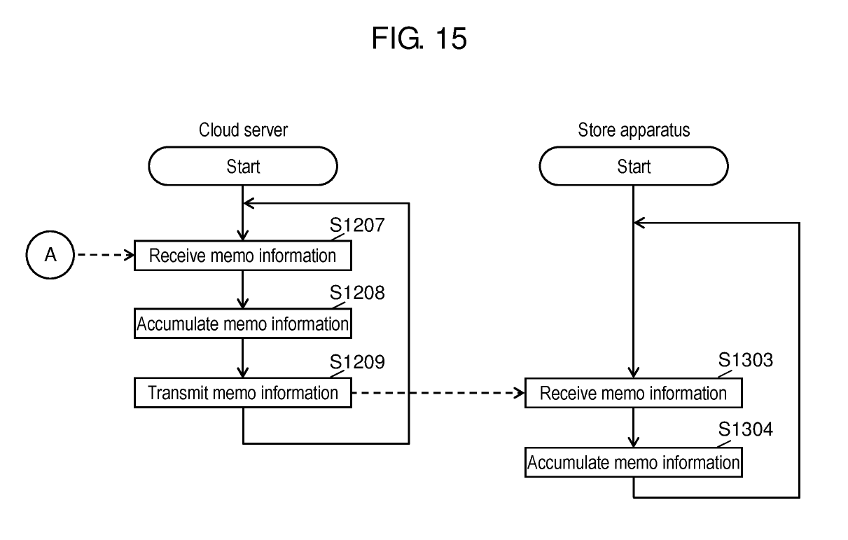

Next, while displaying the advertisement information on display 241, recommendation apparatus 201 monitors whether the driver presses the memo button via input device 230 (step S1013). When the memo button (refer to FIG. 14B) is pressed (Yes in step S1013), recommendation apparatus 201 transmits memo information regarding the advertisement information on the corresponding store together with the driver's ID information to cloud server 300 (step S1014). At this time, the memo information is transmitted from A illustrated in FIG. 13 to A illustrated in the flowchart of FIG. 15 to be described later, and the accumulation operation of the memo information is performed.

On the other hand, when the memo button is not pressed (No in step S1013), or when transmission operation of the memo information is completed (step S1014), recommendation apparatus 201 determines whether the continuously received velocity information is less than 3 km/h (step S1015). Here, 3 km/h, which is a criterion, is an example of velocity for determining whether automobile 200 departs, and is not particularly restrictive.

When recommendation apparatus 201 determines that the velocity information is less than 3 km/h and that automobile 200 is at a stop (Yes in step S1015), recommendation apparatus 201 repeats the operation from step S1012 to step S1015. That is, as long as automobile 200 is at a stop, recommendation apparatus 201 successively repeats, on display 241, display of the advertisement information advanced from before the deleted information, and deletion operation of the displayed advertisement information from RAM 212 and HDD 213. When the accumulated information is all deleted, display of the finally displayed advertisement information may be maintained on display 241. Alternatively, a message saying “There is no accumulated information” may be displayed to notify the user.

On the other hand, when automobile 200 departs again and the velocity information becomes 3 km/h or more (No in step S1015), recommendation apparatus 201 stops display of the advertisement information on display 241 (step S1016). Then, recommendation apparatus 201 returns to step S1004 again, and performs steps of receiving the velocity information and thereafter. At this time, recommendation apparatus 201 displays navigation information, etc. illustrated in FIG. 14A on display 241.

The flow from step S1004 to step S1016 illustrated in FIG. 13 is continuously executed until automobile 200 stops running, such as stopping an engine of automobile 200.

As described above, the display determination operation of the advertisement information is performed in recommendation apparatus 201 that constitutes the information presentation apparatus.

The following describes a specific example of the advertisement information to be displayed on display 241 of recommendation apparatus 201 with reference to FIG. 14A to FIG. 14C.

FIG. 14A to FIG. 14C are image diagrams illustrating the display form of the advertisement information according to the present exemplary embodiment.

FIG. 14A is an image diagram of a screen of the navigation information (for example, map information, current positional information, etc.) displayed on display 241.

FIG. 14B is an image diagram of the screen that displays the outline information of the advertisement information as an example of the display method of the advertisement information on the stores. In this case, FIG. 14B illustrates, for example, an example of displaying the outline information of two stores on one screen.

In a case where the display method of the aforementioned system is set, when automobile 200 stops and the predicted stoppage time is about 20 seconds, for example, recommendation apparatus 201 displays the outline information on display 241, for example, in the order of the advertisement of the store D, advertisement of the store C, advertisement of the store B, and advertisement of the store A, at predetermined intervals (for example, at least 5 seconds). That is, recommendation apparatus 201 displays, on display 241, the outline information on every two stores from the store near the stop position of automobile 200 along running route 203. Specifically, recommendation apparatus 201 first displays the outline information on the store D and the store C on the screen of display 241. Then, when a predetermined time elapses after the display, recommendation apparatus 201 displays the outline information on the store B and the store A on the screen of display 241. The predetermined time is set from the predicted stoppage time based on the number and display amount of the advertisements.

The driver may switch display of the outline information on each store at will through scroll operation of a scroll bar. If display time of the advertisement information is at least 5 seconds within the range of the predicted stoppage time, the outline information may be repeatedly and successively displayed. Furthermore, the display time may be changed arbitrarily according to the number of advertisements to display, within the range in which each advertisement is displayed at least once during the predicted stoppage time.

Furthermore, as illustrated in FIG. 14B, the details button and memo button are displayed for each store on the screen of display 241 that displays the advertisement information. At this time, when the driver presses, for example, the details button via input device 230, the driver may read more detailed advertisement information on the corresponding store, as illustrated in FIG. 14C to be described later. On the other hand, when the driver presses, for example, the memo button via input device 230, recommendation apparatus 201 makes a memo of (stores) the outline information on the corresponding store as memo information.

Although FIG. 14B illustrates the example in which the screen of display 241 displays the advertisement information for every two stores, the present disclosure is not limited to this example. For example, the screen of display 241 may be configured to display one store, or to display three or more stores on each screen.

The screen of display 241 may be configured, when the details button is pressed, to display the detailed information of FIG. 14C on display 241 for a certain period of time, then to return to and display the outline information. In this case, although not illustrated, display 241 that displays the detailed information may be provided with a return button for returning to the outline information, instead of management by time. Furthermore, the screen of display 241 may be configured, after the detailed information is displayed, to maintain the display.

Furthermore, FIG. 14C is an image diagram of the screen in a case of displaying the detailed information on the stores as an example of the display method of the advertisement information. In this case, in FIG. 14C, one screen displays the detailed information on one store. FIG. 14C is the detailed information displayed directly on display 241 in a case where the predicted stoppage time is long, other than a case where the detailed information is displayed from the outline information when the details button of FIG. 14B is pressed.

Specifically, when automobile 200 stops and the predicted stoppage time is long, for example about 60 seconds, recommendation apparatus 201 displays the detailed information on display 241 at predetermined intervals (for example, 10 seconds), for example, in the order of the advertisement of the store D, advertisement of the store C, advertisement of the store B, and advertisement of the store A. That is, recommendation apparatus 201 displays, on display 241, the detailed information on each store from the store near the stop position of automobile 200 along running route 203. Specifically, recommendation apparatus 201 first displays the detailed information on the store D on the screen of display 241. Then, when the predetermined time elapses after the display, recommendation apparatus 201 displays the detailed information on the store C. Similarly, when the predetermined time elapses after displaying the detailed information on the store C on the screen, recommendation apparatus 201 displays the detailed information on the store B. Furthermore, when the predetermined time elapses after displaying the detailed information on the store B on the screen, recommendation apparatus 201 displays the detailed information on the store A.

The driver may switch display of the detailed information at will through scroll operation of the scroll bar. If display time of the advertisement information is, for example, at least 10 seconds within the range of the predicted stoppage time, the detailed information may be repeatedly and successively displayed. Furthermore, display time may be changed arbitrarily according to the number of advertisements to be displayed, within the range in which each advertisement is displayed at least once during predicted stoppage time.

Furthermore, as illustrated in FIG. 14C, the memo button is displayed on the screen of display 241 that displays the detailed information on the store. When the driver presses the memo button via input device 230, recommendation apparatus 201 makes a memo of (stores) the detailed information on the corresponding store as memo information.

As described above, according to the predicted stoppage time, the advertisement information such as the outline information, detailed information, and the like on each store is displayed on display 241 of recommendation apparatus 201.

### [2-5. Accumulation of the Memo Information and Coupon Issue Operation]

Next, the following describes the accumulation operation of the memo information transmitted from recommendation apparatus 201 of information presentation system 100 with reference to FIG. 15.

FIG. 15 is a flowchart illustrating the accumulation operation of the memo information according to the present exemplary embodiment.

First, as illustrated by A of FIG. 15, cloud server 300 receives the memo information transmitted via transmitter and receiver 220 of recommendation apparatus 201 from A illustrated in step S1014 of FIG. 13, together with the ID information of the user such as a driver (step S1207). Cloud server 300 then accumulates the received memo information together with the user's ID information in the storage medium, such as HDD 313 (step S1208).

Next, cloud server 300 transmits the accumulated memo information together with the user's ID information to transmitter and receiver 420 of store apparatus 401 (step S1209). Here, transmission of the memo information from cloud server 300 to store apparatus 401 is not limited to transmission performed with timing illustrated in FIG. 15, and may be performed any time when the memo information is previously accumulated in cloud server 300. In addition, cloud server 300 may transmit the memo information and ID information in response to an acquisition request from store apparatus 401.

Next, store apparatus 401 receives the memo information transmitted from cloud server 300 via transmitter and receiver 420, together with the user's ID information (step S1303). Store apparatus 401 accumulates the received memo information and the user's ID information in the storage medium such as HDD 413 (step S1304).

The accumulation operation of the memo information transmitted from recommendation apparatus 201 of information presentation system 100 is performed as described above.

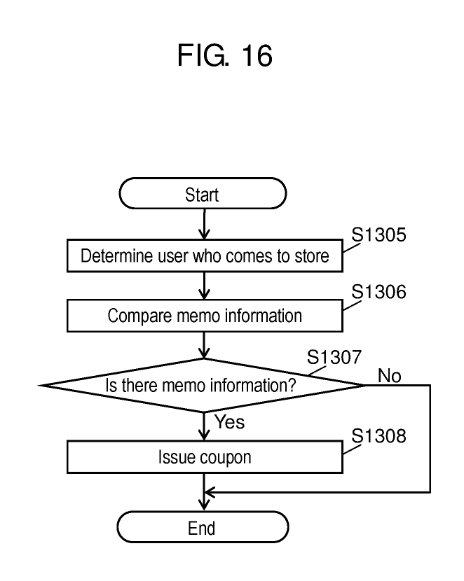

The following describes a coupon issue operation to be performed by store apparatus 401 with reference to FIG. 16 as an example of utilization of the aforementioned memo information and the ID information accumulated in the storage medium of store apparatus 401.

FIG. 16 is a flowchart illustrating the coupon issue operation according to the present exemplary embodiment.

As illustrated in FIG. 16, store apparatus 401 first determines a user who comes to the store (step S1305). Store apparatus 401 implements the determination, for example, through hold of a store card or the like the user owns over a card reader built into store apparatus 401 installed in store 400, the store card containing the ID information. In addition, through hold of the store card over the card reader, recommendation apparatus 201 may determine that the user comes to the store, and may transmit the user's visit and ID information to store apparatus 401 of store 400 via cloud server 300 for the determination.

Next, store apparatus 401 compares the memo information accumulated in the storage medium with the user's ID information (step S1306). Specifically, of the memo information accumulated in HDD 413, store apparatus 401 compares the ID information read by the card reader with the associated memo information. At this time, if there is corresponding memo information, store apparatus 401 extracts the memo information.

Store apparatus 401 then determines whether the extracted memo information contains the ID information of the user who comes to the store (step S1307). At this time, when there is no memo information with the ID information on the user who comes to the store (No in step S1307), store apparatus 401 ends the operation without issuing the coupon.

On the other hand, when the extracted memo information contains the ID information on the user who comes to the store (Yes in step S1307), store apparatus 401 issues the coupon to the user who comes to the store (step S1308).

As described above, the coupon issue operation is performed by store apparatus 401 utilizing the memo information.

The coupon issue operation illustrates an example of using the memo information, and is not restrictive. For example, the memo information may be used for analysis of advertising effectiveness. Here, the analysis of advertising effectiveness includes in what geographical range the advertisement information is to be put for producing an effect, and what kind of coupon issue is effective for a distance and time from the movable body, such as automobile 200 and person to which the advertisement information is to be put. This allows information dissemination places, such as stores and event sites, to analyze the effectiveness of an effect of the advertisement to provide, and to provide the user with the advertisement information effectively.

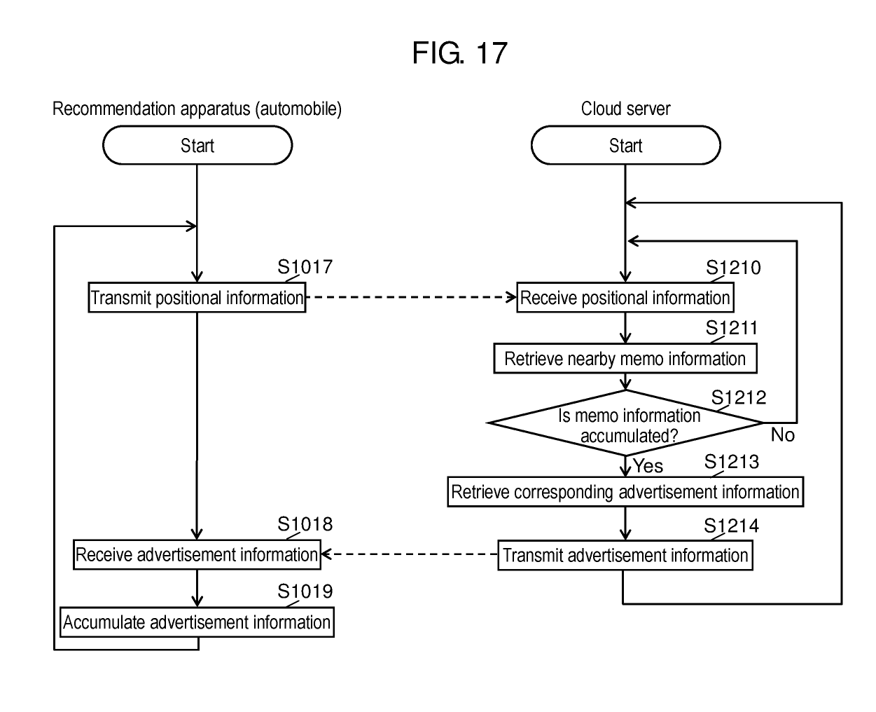

The following describes another example in which store apparatus 401 utilizes the memo information with reference to FIG. 17.

FIG. 17 is a flowchart illustrating the accumulation operation of the advertisement information utilizing the memo information according to the present exemplary embodiment. FIG. 17 illustrates the operation flows of recommendation apparatus 201 and cloud server 300. The operation of each step illustrated in FIG. 17 is basically similar to the operation of each step described with reference to FIG. 6.

First, in a similar manner to the operation flow illustrated in FIG. 6, transmitter and receiver 220 of recommendation apparatus 201 transmits the ID information of the user, such as a driver, together with the positional information on automobile 200 (step S1017). Here, the ID information is previously registered into the memory of recommendation apparatus 201, etc.

At this time, the accumulation operation of the advertisement information illustrated in FIG. 17 utilizes the memo information made when automobile 200 runs identical running route 203 before, to display the advertisement information on the store.

Specifically, cloud server 300 receives the transmitted positional information and ID information (step S1210). Then, of the advertisement information on the store near the current positional information on running automobile 200, cloud server 300 retrieves the advertisement information with memo information left in the past (step S1211).

Next, cloud server 300 finds out whether the memo information is accumulated in the memory such as RAM 312 and HDD 313 (step S1212).

When the memo information is not accumulated (No in step S1212), cloud server 300 returns to the standby state of receiving the positional information of step S1210.

On the other hand, when the memo information is accumulated (Yes in step S1212), based on the retrieved memo information, cloud server 300 retrieves the advertisement information on the store corresponding to the memo information (step S1213).

Next, cloud server 300 transmits the retrieved advertisement information to recommendation apparatus 201 (step S1214). Then, after transmitting the advertisement information to recommendation apparatus 201, cloud server 300 returns to the standby state of receiving the positional information of step S1210.

Next, in a similar manner to the operation flow illustrated in FIG. 6, recommendation apparatus 201 receives the advertisement information on the store transmitted from cloud server 300 via transmitter and receiver 220 (step S1018). Recommendation apparatus 201 then accumulates the received advertisement information in the memory (step S1019), and returns to step S1017.

The accumulation operation of the advertisement information stored in the past utilizing the memo information into recommendation apparatus 201 is performed as described above.

This allows the user, such as a driver, to more easily notice information that is not noticed until now, by using the advertisement information on the store retrieved based on the memo information accumulated in the past.

### Other Exemplary Embodiments

As described above, the exemplary embodiment has been described as illustration of the technique disclosed in the present application. The technique in the present disclosure, however, is not limited to this example, and may be applied to exemplary embodiments to which change, replacement, addition, and omission are made. In addition, it is also possible to make a new exemplary embodiment by combining components described in the aforementioned exemplary embodiment.

Therefore, other exemplary embodiments will be described below.

That is, the present exemplary embodiment has described an example of executing instructions for leaving the memo information by pressing the memo button displayed on the display. However, the present disclosure is not limited to this example. For example, the instructions for leaving the memo information may be executed by voice input.

In addition, the present exemplary embodiment has illustrated the configuration to accumulate and display the advertisement information on store 400 based on the address of store 400. However, the present disclosure is not limited to this example. For example, the present exemplary embodiment may be configured so that an owner or salesclerk of store 400 specifies and displays a geographical place at which they desire to put the advertisement information on store 400. In this case, the advertisement information on store 400 may be accumulated and displayed based on the specified place.

In addition, in the present exemplary embodiment, the advertisement information that recommendation apparatus 201 displays may be filtered, for example, with a user attribute. In this case, in addition to the positional information, recommendation apparatus 201 first transmits the user attribute to cloud server 300. Next, cloud server 300 performs matching with the user attribute previously set in the advertisement information on each store. Cloud server 300 may be configured, when matched, to extract and deliver only applicable advertisement information.

In addition, the present exemplary embodiment may be configured, of the accumulated advertisement information, to present the advertisement information which fails to finish display during stoppage time of the automobile, during subsequent stop or subsequent driving opportunities.

In addition, the present exemplary embodiment may be configured to provide the advertisement information in consideration of a lane condition of a road along which the automobile runs. For example, the present exemplary embodiment may display only advertisement information near the lane in which the automobile is positioned. Specifically, in a one-way road, the present exemplary embodiment displays only advertisement information on a store such as a store located ahead along a running direction, and does not display advertisement information on a store the automobile runs past. In addition, the present exemplary embodiment may be configured to display only advertisement information on a store which the automobile may go by turning left. Furthermore, the present exemplary embodiment may be configured to display only advertisement information on a store that the automobile may go through a road that is not congested based on the navigation information.

Although the present exemplary embodiment has described an example of automobile as the movable body, the present exemplary embodiment is not limited to this example. For example, the movable body may be a moving person.

In this case, advertisement information on a store that exists within a range of predetermined threshold is accumulated in a memory of an information presentation apparatus, such as a portable information terminal, along the person's movement route.

Then, of the accumulated advertisement information, the present exemplary embodiment displays, on a display of the information presentation apparatus, advertisement information regarding a place, for example, a place at a short distance from the person or a place where time after acquisition is short, with predetermined timing such as when movement stops. At this time, if the number of advertisements to display is set, the advertisement information will be sequentially displayed within this range.

Next, of the displayed advertisement information, impressive advertisement information may be stored as memo information and may be utilized for issue of a coupon, etc.

Since the aforementioned exemplary embodiments are intended to illustrate the technique in the present disclosure, various changes, replacements, additions, omissions, etc. may be made within the scope of the appended claims and equivalents thereof.

What is claimed is:

1. An information presentation apparatus comprising:
a transmitter and receiver that transmits and receives a plurality of pieces of advertisement information regarding respective places along a movement route of a movable body as the movable body moves;
a memory that accumulates the plurality of pieces of advertisement information received by the transmitter and receiver;
a display that displays the plurality of pieces of advertisement information; and
a controller that controls preferential display of advertisement information on the display with predetermined timing, the advertisement information being among the plurality of pieces of advertisement information accumulated in the memory, and regarding each of the places at a short distance from the movable body that acquires the plurality of pieces of advertisement information along the movement route of the movable body, or regarding each of the places where time after acquisition is short.

2. The information presentation apparatus according to claim 1, wherein the controller controls display of the plurality of pieces of advertisement information regarding the places on the display in increasing order of distance from the movable body that acquires the plurality of pieces of advertisement information, or in increasing order of time after acquisition.

3. The information presentation apparatus according to claim 1, wherein the movable body is a vehicle.

4. The information presentation apparatus according to claim 3, wherein the predetermined timing is time when the controller determines that the vehicle has stopped.

5. The information presentation apparatus according to claim 1, wherein each of the places is a store or an information dissemination place.

6. The information presentation apparatus according to claim 1, wherein the plurality of pieces of advertisement information include outline information and detailed information.

7. The information presentation apparatus according to claim 1, wherein the controller controls display on the display based on stopping time of the information presentation apparatus, and on a display amount of the plurality of pieces of advertisement information.
